(19) United States
(12) Patent Application Publication
(10) Pub. No.: US 2008/0189784 A1
(43) Pub. Date: Aug. 7, 2008

(54) Method and Apparatus for Deep Packet Inspection

(75) Inventors: William Mangione-Smith, Kirkland, WA (US); Young H. Cho, Chatsworth, CA (US)

Correspondence Address: Vista IP Law Group LLP, 2040 MAIN STREET, 9TH FLOOR, IRVINE, CA, 92614, US

(73) Assignee: THE REGENTS OF THE UNIVERSITY OF CALIFORNIA, Oakland, CA (US)

(21) Appl. No.: 11/574,878

(22) PCT Filed: Sep. 7, 2005
(86) PCT No.: PCT/US05/31644

§ 371 Date: Mar. 7, 2007

Related U.S. Application Data
(60) Provisional application No. 60/608,732, filed on Sep. 10, 2004.
(60) Provisional application No. 60/668,029, filed on Apr. 4, 2005.

(51) Int. Cl. G06F 11/00

(52) U.S. Cl. 726/23

(57) ABSTRACT

A system and method is provided for detecting malicious data such as, for example, viruses in a computer network. More specifically, system and method utilizes filters to detect pre-identified patterns or threat signatures in a data stream. In one embodiment, a deep packet inspection system for detecting a plurality of malicious programs in a data packet received from a network, wherein each malicious program has a unique pattern comprising a plurality of segments, includes a plurality of pattern detection modules configured to receive one or more data packets in parallel, wherein each of the plurality of pattern detection modules has an output, and one or more long pattern state machines coupled to the outputs of the plurality of pattern detection modules. The deep packet inspection system is configured to detect a pattern of any length at any location within a data packet.

### REFERENCE TO RELATED APPLICATIONS

This Application claims priority to U.S. Provisional Patent Application Nos. 60/608,732 filed on Sep. 10, 2004 and 60/668,029 filed on Apr. 4, 2005. The above-identified Patent Applications are incorporated by reference as if set forth fully herein.

### STATEMENT REGARDING FEDERALLY SPONSORED RESEARCH AND DEVELOPMENT

The U.S. Government may have a paid-up license in this invention and the right in limited circumstances to require the patent owner to license others on reasonable terms as provided for by the terms of National Science Foundation Grant No. CCR-0220100.

### FIELD OF THE INVENTION

The field of the invention generally relates to methods and systems used for detecting malicious data such as, for example, viruses in a computer network. More specifically, the field of the invention relates to filters used to detect pre-identified patterns or threat signatures in a data stream.

### BACKGROUND OF THE INVENTION

Due to an increasing number of network worms and viruses, computers connected to large networks, such as the Internet, have become vulnerable to being infected by such malicious data. To prevent infection, many computers use “firewalls,” which are programs that monitor data packets coming from the network in search of known viruses and/or worms. Firewalls generally include content filtering programs that search the incoming data packets for patterns that correspond to known malicious code, such as worms and viruses. Typical content filtering programs simply analyze the headers of the packets in search for virus/worm patterns; however, worms and/or viruses may not reside in the headers but instead in the payload, i.e., the portion of the data packet containing the substantive data. Thus, the typical content filtering programs would not detect such viruses and/or worms. For example, one such notorious Internet worm is known as Sobig-F, which alone accounted for $29.7 billion of economic damages worldwide. The Sobig-F worm enters computers from the Internet as an e-mail. In response, deep packet filters have been developed, which analyze not only the header information, but also the payload of the incoming data packets. Deep packet filtering systems are also referred to as network intrusion detection systems (“NIDS”).

FIG. 1 illustrates the operation of an example deep packet filter 10 known in the art, which is typically implemented as software and/or firmware executed by a general purpose processor, or implemented in a reconfigurable Read Only Memory (“ROM”). Data transmitted over the Internet is generally transmitted in fragmented data packets, so the filter 10 includes a packet normalizer 15, which assembles the fragmented packets into a complete data packet for analysis. This is commonly referred to as normalization. Before assembly, the normalizer 15 strips the fragmented packets of any abnormalities. A virus or worm may utilize overlapping fragmented packets to avoid detection; however, a normalized data packet would eliminate that risk. The resulting normalized packets 18 would then be analyzed for patterns corresponding to known malicious code, such as viruses and/or worms.

The header portion 20 of the normalized packet 18, which precedes the payload 25, generally contains information about the type of payload 25 in the packet 18. For example, the header portion 20 may indicate whether a data packet 18 is an email or an executable file. The deep packet filter 10 includes a static inspection module 30 that classifies the normalized packet 18 using the header portion 20 of the packet 18. Such information can be helpful in determining the type of malicious code to search for. Static inspection modules 30 known in the art include PMC Sierra ClassiPI and Broadcom Strata Switch II.

The filter 10 further includes a dynamic inspection module 35 that searches the payload 25 for patterns corresponding to known malicious code. After the data packets 18 have been analyzed, the data packets 18 having patterns that correspond to known malicious code are removed by a packet filter 40, and the remaining packets 18 are sent to a user's computer as “safe packets.”

The content of the payload portion 25 of a data packet is dictated by the computer application, e.g., an email application or file transfer application. Thus, not only does the size of the payload portion 25 vary, but also the size of the malicious code and the location of the malicious code within the payload. Accordingly, the dynamic filter 35 compares all known patterns at every byte of the payload 25, which can be computationally intensive. Thus, for high-speed networks, wherein a computer can receive data at 1+ gigabytes per second (“Gbps”), a deep packet filter 10 will consume a substantial portion of the available processing power analyzing the received data. For example, one known NIDS is the Snort NIDS, which includes approximately 500 patterns. The Snort system can sustain a bandwidth of less than 50 megabytes per second (“Mbps”) using a dual 1 Gigahertz (“GHz”) Intel Pentium® 3 system.

Moreover, with the emergence of new worms and viruses, the rules set within the filter 10 need to be constantly updated and thus need to be reprogrammed, recompiled, and/or reconfigured to accommodate the updated rules set. This can take more than several hours to complete, particularly for a reconfigurable ROM based filter, thus adding more overhead to the computer system. Accordingly, an improved deep packet filter system would be desirable.

### SUMMARY OF THE INVENTION

The field of the invention generally relates to methods and systems used for detecting malicious data such as, for example, viruses in a computer network. More specifically, the field of the invention relates to filters used to detect pre-identified patterns or threat signatures in a data stream.

In one embodiment, a deep packet inspection system for detecting a plurality of malicious programs in a data packet received from a network, wherein each malicious program has a unique pattern comprising a plurality of segments, includes a plurality of pattern detection modules configured to receive one or more data packets in parallel, wherein each of the plurality of pattern detection modules has an output, and one or more long pattern state machines coupled to the outputs of the plurality of pattern detection modules. The deep packet inspection system is configured to detect a pattern of any length at any location within a data packet.

In another embodiment, a deep packet inspection system includes a reconfigurable deep packet filter and a dynamic deep packet filter coupled to the reconfigurable deep packet filter in parallel.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 illustrates a deep packet filter known in the art.

FIG. 2 illustrates a pattern detection module in accordance with a preferred embodiment of the present invention.

FIG. 3a illustrates hashing data at a fixed offset.

FIG. 3b illustrates hashing data at a variable offset.

FIG. 4 illustrates a switched pipeline in accordance with a preferred embodiment of the present invention.

FIG. 5 illustrates a plurality of pattern detection modules in parallel in accordance with a preferred embodiment of the present invention.

FIG. 6 illustrates a predictive long pattern state machine in accordance with a preferred embodiment of the present invention.

FIG. 7 illustrates a pattern divider in accordance with a preferred embodiment of the present invention.

FIG. 8 illustrates the operation of a pattern detection system in accordance with a preferred embodiment of the present invention.

FIG. 9 illustrates a retrospective long pattern state machine in accordance with a preferred embodiment of the present invention.

FIG. 10 illustrates a keyword tree.

FIG. 11 illustrates a deep packet filter in accordance with a preferred embodiment of the present invention.

FIG. 12a illustrates a deep packet filter in accordance with another preferred embodiment of the present invention.

FIG. 12b illustrates a deep packet filter in accordance with another preferred embodiment of the present invention.

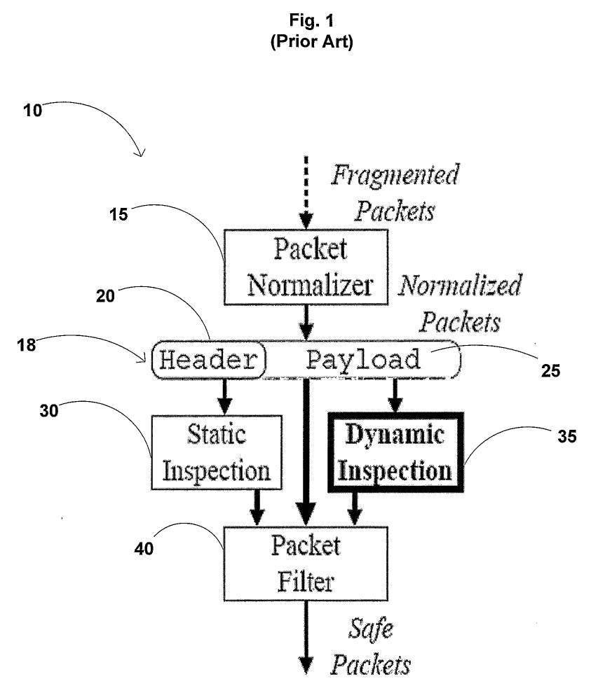

### DETAILED DESCRIPTION OF THE PREFERRED EMBODIMENTS

A dynamic pattern search system in accordance with a preferred embodiment is described herein. The system may be implemented as software, firmware, and/or one or more integrated circuits (“ICs”), such as a processor, field programmable gate array (“FPGA”) or application specific integrated circuit (“ASIC”). Preferably, the pattern search system is implemented as a co-processor to a general purpose processor to alleviate the stress that may be placed on the general purpose processor if the pattern search system were to be implemented as software to be executed by the general purpose processor.

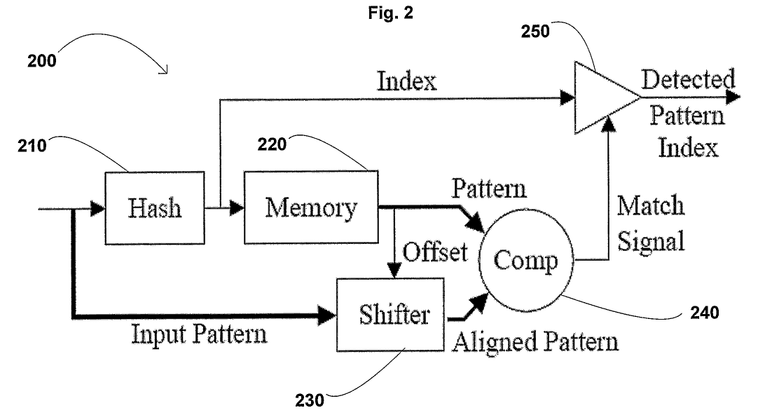

Turning to FIG. 2, a pattern detection module 200 (“PDM”) is shown. The pattern detection module 200 includes a hash module 210 having an output coupled to a memory module 220 and an output circuit 250 of the module 200. The memory module 220 stores patterns corresponding to known malicious code. The input of the module 200 is coupled to the hash module 210 and a shifter module 230, which retrieves data from the memory module 220 and has an output coupled to a comparator 240, which also retrieves data from the memory module 220.

During operation, data received from a network, such as payload data, is received by the pattern detection module 200 as an input pattern. At every clock cycle, at least a portion of the input pattern is hashed by the hash module 210 to generate an index. The index is forwarded to the memory module 220, which uses the index as an address of a particular pattern stored within the memory module 220. The pattern retrieved from the memory module 220 is then forwarded to the comparator 240, which compares the pattern from the memory module 220 with the input pattern. If there is an exact match, then the index is outputted 250 as a unique identifier to a detected pattern, e.g., pattern corresponding to malicious code. As mentioned above, because malicious code may not have a fixed length, the lengths of the corresponding patterns also may not be fixed. Thus, the maximum length of the input pattern that is used to generate the hashed index is the minimum length of the patterns detectable by the PDM 200. Moreover, the maximum range of the hashed index determines the maximum entries that can be stored in the memory module 220. For instance, if two bytes of the input pattern is hashed to generate the index, then the PDM 200 can be configured to detect a maximum of 65,536 (2^{8×2}) patterns with a minimum length of two bytes.

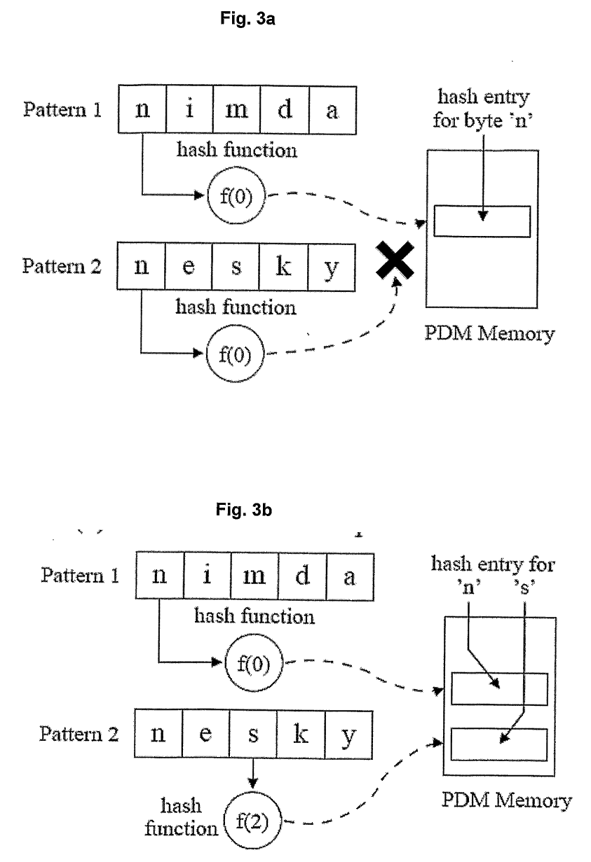

Turning to the memory module 220, as mentioned above, the address of each stored pattern within the memory module 220 corresponds to the hashed result of at least a portion of the pattern, e.g., a substring. If an index is generated by hashing a substring of the input pattern at a fixed byte offset, then overly strict constraints would be placed on what patterns could be detected by a PDM 200. For example, turning to FIG. 3a, if only the first byte of a pattern were hashed, then hashing pattern 1 and pattern 2 would return the same index, but only one of the two patterns could be stored in that address. In accordance with a preferred embodiment, to increase the number of patterns to be detected, an index is generated by hashing any substring at any position within an input pattern.

As shown in FIG. 3b, if any substring within an input pattern is hashed at any position within the pattern, then both pattern 1 and pattern 2 can be stored in the memory module 220, because each would have a unique index. Given that several possible hash indices for each pattern may be generated, statistical analysis can be applied to the patterns to be stored in the memory module 220 so that the patterns are stored more efficiently. To support this option in the PDM 200, the byte offset of the substring used in the pattern is preferably stored in the memory module 220 along with the pattern. Turning back to FIG. 2, the shifter module 230 retrieves the offset corresponding to the retrieved pattern from the memory module 220 and shifts the input pattern accordingly by the retrieved offset. Then, the shifted input pattern is compared against the pattern retrieved from the memory module 220 by the comparator module 240. If the patterns match, then the index is forwarded to the output circuit 250 as an index to a detected pattern, i.e., detected malicious code. A corresponding computer system may then handle the data packet with the detected pattern, e.g., notify the user and/or discard the data packet.

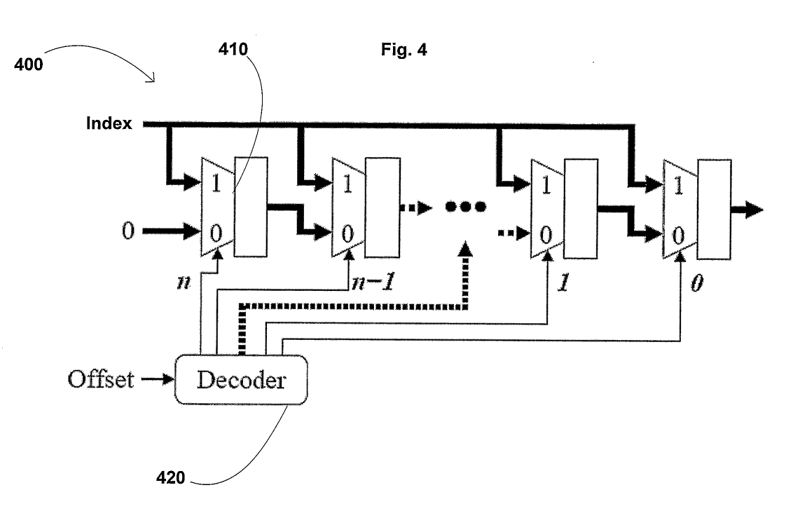

Turning to FIG. 4, a switched pipeline 400 may be applied to the index output 250 of the PDM 200 to adjust the timing of the index output 250. The switched pipeline 400 includes a plurality of cascaded multiplexers 410, each coupled to the index output 250 and each controlled by a decoder 420 receiving the offset from the memory module 220. Because the indices in the memory module 220 are generated using the substring of the corresponding stored pattern at any offset, the timing of the index output 250 may not indicate the starting byte of the detected pattern. By using the offset value with the switched pipeline 400, the timing of the index output 250 can be adjusted to correspond with the start of the detected pattern.

As the number of patterns increases, some may not be mapped on to the same PDM 200 due to the limited number of unique substring combinations. Therefore, more than one PDM 200 may be used to detect patterns in parallel. In such a case, more than one PDM 200 may generate the same index from the respective hash module 210. However, despite the same hash index, only one PDM 200 will signal a match since no two patterns will be the same. However, for some patterns, more than one PDM 200 can produce a valid index during the same cycle. This is true when one pattern matches the beginning substring of another pattern. In other words, a longer pattern may overlap a shorter pattern from the starting byte. Such patterns are referred to as “overlapping patterns.” Therefore, when more than one index is detected, it is sufficient to output the index for the longest pattern.

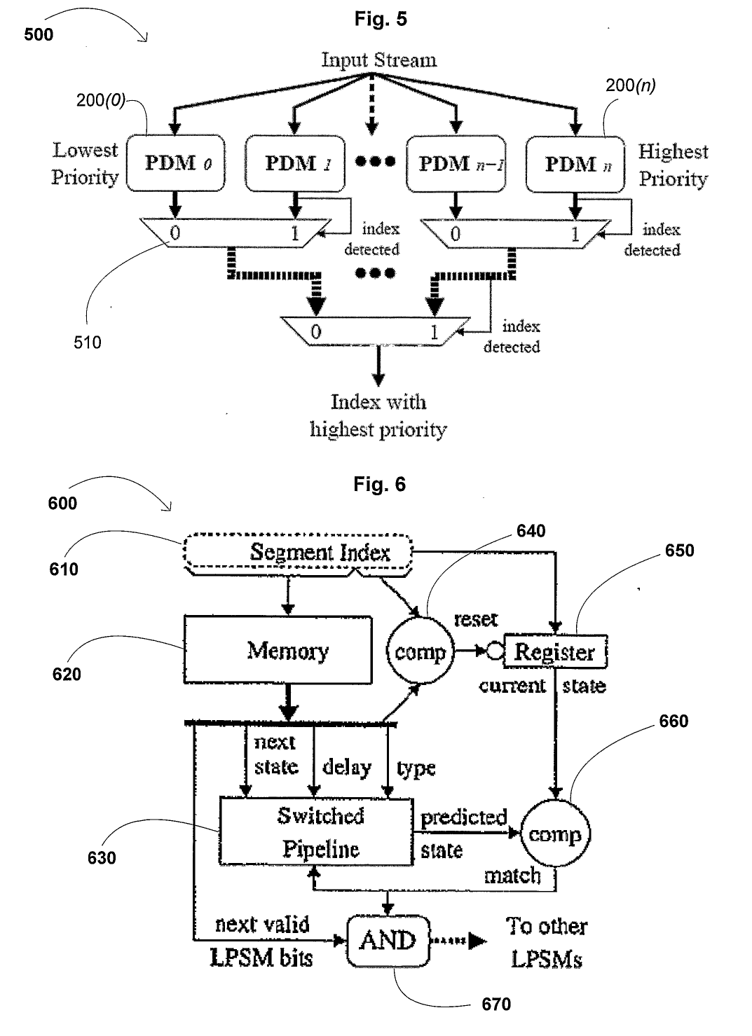

Turning to FIG. 5, a prioritized parallel PDM module 500 is shown. The module 500 includes a plurality of PDMs 200₀₋ₙ in parallel coupled to a plurality of multiplexers 510 that are cascaded in a pyramid form to implement priority. The plurality of PDMs 200₀₋ₙ are coupled to an input stream in parallel. By storing the longer of any conflicting patterns in the PDM 200₀₋ₙ with the higher priority, the parallel PDM module 500 is capable of detecting all of the overlapping patterns. Each PDM 200₀₋ₙ is capable of detecting patterns of lengths that are less than or equal to that of the widest memory module of all the PDMs 200₀₋ₙ. Given a typical set of patterns, a developer may choose to use different sized memory modules 220 for different PDMs 200₀₋ₙ based on a typical range of patterns. By statistically analyzing the patterns, the logic resource may be used more efficiently. To maintain consistent output timing for the PDMs 200₀₋ₙ, it may be preferable that a PDM 200 analyzing smaller patterns have extra stages of switched pipeline 400 to match the PDM 200 analyzing larger patterns.

As mentioned above, the lengths of the patterns may vary; however, building PDMs 200 using a memory module 220 wide enough to store the longest possible pattern would be inefficient. One approach to accommodate patterns of varying lengths is to utilize a long pattern state machine (“LPSM”), which detects patterns that are longer than the width of the memory module 220 of a PDM 200.

Since not all analyzed data segments or substrings are part of a long pattern, the segments can be individually hashed into segment indices to increase LPSM memory utility. The LPSM examines the sequence of segment indices for the correct ordering and timing to detect the corresponding long pattern. An implementation of a predictive LPSM 600 is shown in FIG. 6. A predictive LPSM 600 includes a memory module 620 that stores state information, i.e., an index within the sequence of segment indices of a long pattern. Each state is identified based on, at least in part, the index output 250 of a PDM 200. An entry within the memory 620 stores information about the current state, i.e., current index, and “type” information, which indicates whether the index of the current state is the first, middle, or the last segment of a long pattern. An entry also stores what the next state is and timing information, e.g., when it is expected to be detected by a PDM 200.

The output of the memory 620 is coupled to a switched pipeline 630, such as the switched pipeline 400 described above. The process of analyzing the sequence of segment indices is initiated when the type of the current index indicates that the corresponding segment is the first of the long pattern segments. This is achieved by a comparator module 640, which indicates whether to analyze the next state as the next segment in a pattern, which is controlled by a register 650. If the segment analyzed is the first of a long pattern, then using the timing information, the expected next state is forwarded to the switched pipeline 630 to adjust timing. When the next index reaches the end of the pipeline 630, the next index is forwarded to a comparator module 660, which compares the next index with the actual current state to determine whether a match has occurred.

When the previous next state is an exact match of the current state at the end of the pipeline, the expected next state is forwarded into the pipeline 630. If the expected next state does not match the current state, the process is terminated without any output. Otherwise, the process continues until the current state is specified as the last segment of the long pattern. Then, the last matching index is forwarded as an index for the detected long pattern.

Depending upon the length of the memory 620 of an LPSM 600 and the length of the pattern indices, more than one entry may be used for the same address. Under this circumstance, more than one LPSM 600 can run in parallel to detect more than one sequence of states.

In order to interoperate between LPSMs 600, the match data from comparator 660 is forwarded to the modules that contain all corresponding next state information for the current state. When any of the LPSMs 600 receive the match data, the receiving LPSM's 600 next state is forwarded to the pipeline 630 regardless of the result in its own comparator 660.

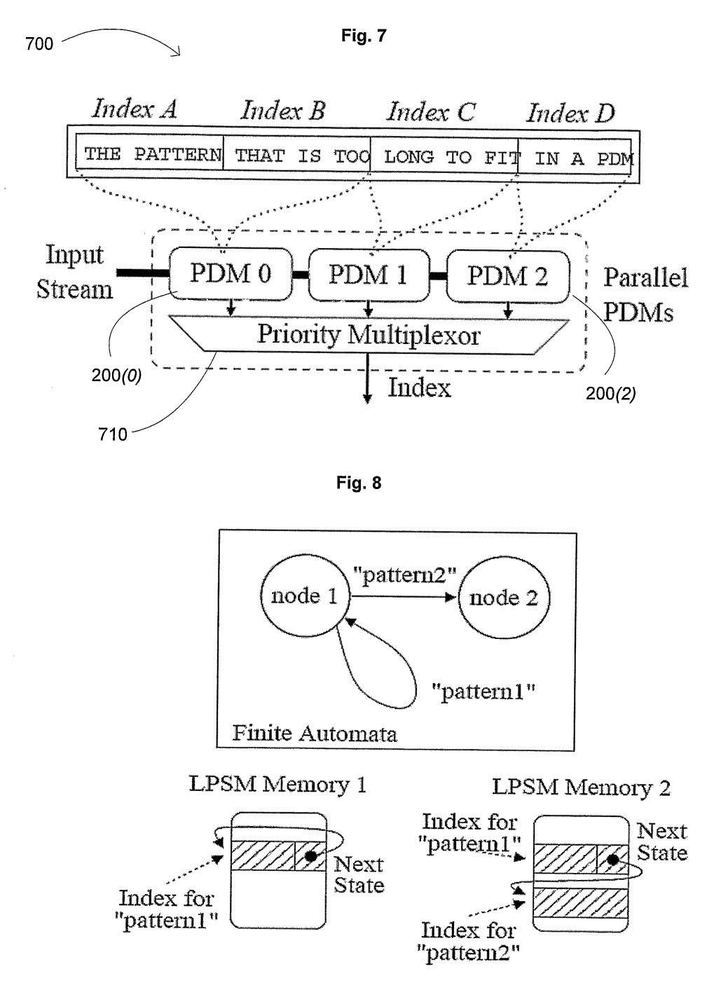

Before detecting the order of indices, the long patterns need to be divided into several short pattern segments. If the order and the timing of the segment sequence are tracked, the corresponding long pattern can be detected. One approach for dividing the long patterns is to use a pattern divider 700, an example of which is shown in FIG. 7. The pattern divider 700 divides the long pattern into smaller segments that fit in to a specific PDM 200_{0 to 2}. These segments are stored in the PDMs 200_{0 to 2} along with flag bits that indicate that they are segments of long patterns. The PDMs 200_{0 to 2} have outputs coupled to a priority multiplexer 710, such as that described in the prioritized parallel PDM module 500 above.

Parallel predictive LPSM 600 is a natural platform to map regular expressions. Regular expressions can be represented in the form of non-deterministic finite automata (“NFA”), which is known in the art. All the inputs to the NFA can be recognized by the PDM 200 as sequence of short segments while the transition can be mapped on the parallel LPSMs 600. For the each index entry, each LPSM 600 can point to the next index that is the next node of the NFA. In similar fashion, deterministic finite automata (“DFAs”) can also be mapped in to the LPSMs 600.

For instance, FIG. 8 shows a node, node 1, with edges that points to itself and to another node, node 2. Such finite automata can be represented in the parallel predictive LPSM 600, where an entry on one unit points to itself and the same entry on another unit points to the next index.

One approach to divide and represent the patterns is a keyword tree, which is known in the art. A keyword tree is used in many software pattern search algorithms, including the Snort IDS. A keyword tree 800 in FIG. 10 shows how it can optimize the memory utility by reusing the keywords. The conversion not only reduces the amount of required storage, but also narrows the number of potential patterns as the pattern search algorithm traverses the tree 800. A key concept of keyword tree 800 may be applied to build the set of pattern segments from the long patterns that fits in the PDM 200 memories 220 by reusing pattern segments that appear in more than one pattern. First, the pattern set is analyzed to form a keyword tree 800. Once keyword trees 800 are generated, the keywords are stored as pattern segments in the PDMs 200 and the edges of the trees 800 are stored at the state transitions in parallel LPSMs 600. The optimization allows duplicate pattern segments to be collapsed into a single segment to save PDM 200 memory space. More information about keyword trees is described in A. V. Abo and M. J. Corasick, “Efficient String Matching: An Aid to Bibliographic Search”, Communications of the ACM, pgs. 333-340, (ACM Press, June 1975), which is hereby incorporated by reference in its entirety.

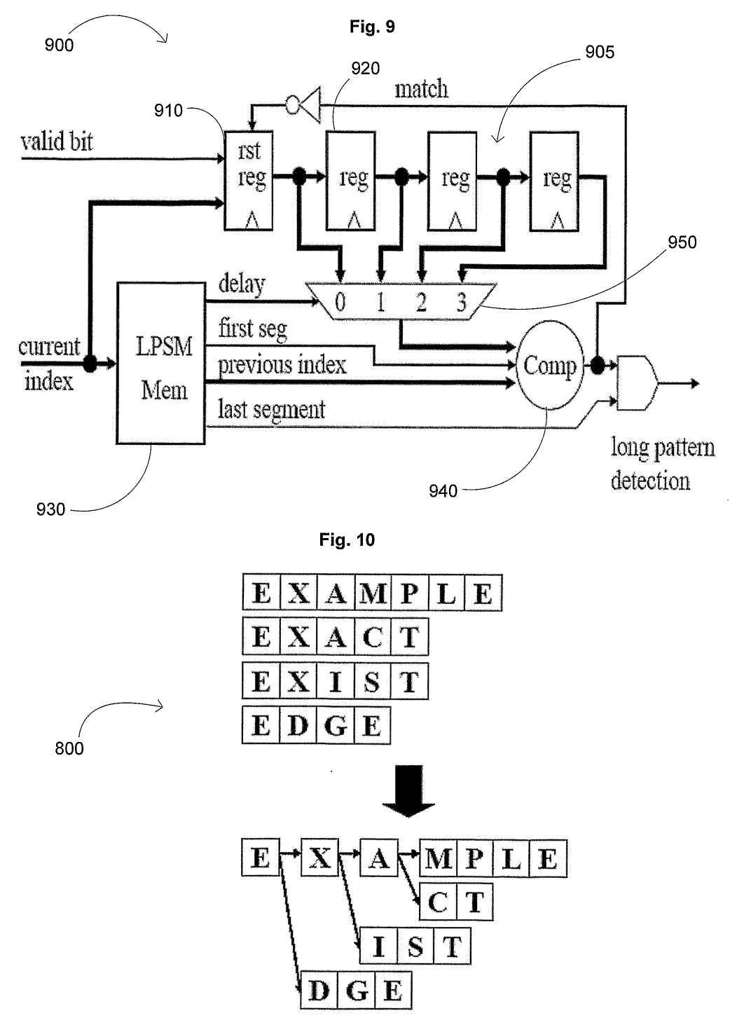

An alternative implementation of an LPSM 900 is shown in FIG. 9. The LPSM 900 includes a memory 930 coupled to a switched pipeline 905 having a plurality of registers 920 coupled to a multiplexer 950, which is also coupled to a comparator 940. The memory 930 first forwards the previously detected index according to the delay information stored for the current index. The delay information is forwarded to the pipeline 905. If the previous index is valid at that stage of the pipeline 905, it compares the index value with the expected index stored in the memory 930. When there is a match, a valid bit for the current index is passed to the next stage of the pipeline 930. Otherwise, the valid bit and the detected current index are invalidated.

The first segment bit may cause the comparator 940 to always output a match. By asserting the first segment bit of the first index entry, the process to analyze the sequence of segment indices is initiated. This LPSM 900 is referred to as a retrospective LPSM 900. Although retrospective LPSM 900 may not be an intuitive choice for mapping finite automata with cyclic paths, it is a preferable module for a pattern keyword tree 800, especially if nodes of the tree 800 consist of many children nodes. If all keywords of a given tree 800 have less children than the number of parallel LPSMs 600, predictive LPSM 600 may be sufficient; otherwise, the number of parallel predictive LPSMs 600 must be increased. In retrospective LPSM 900, the keyword tree 800 is mapped on to the LPSM memory 930 in a bottom-up fashion. Therefore, as long as all the indices are addressable in the LPSM 900, the keyword tree 800 can be successfully mapped.

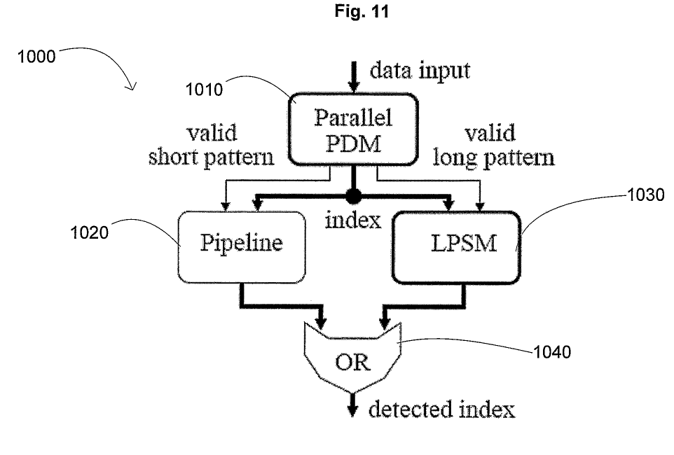

Turning to FIG. 11, a simplified block diagram of a dynamic deep packet inspection system 1000 is shown. The structure of the system 1000 can be based on a multi-gigabit FPGA filter system, which enables operation on a high bandwidth network. The short patterns can be detected using only a PDM 1010 whereas the long patterns are detected using both the PDM 1010 and the LPSM modules 1030. Delay is added to the PDMs 1010 via a switched pipeline 1020 so that the timing of the short pattern segment detection is the same as the long pattern, so that the output maybe shared. Unlike the reconfigurable deep packet inspection systems known in the art described above, which requires recompilation of the design file, the patterns can be updated by changing the content of the memories in LPSMs 1030 and PDMs 1010. Therefore, the above system 1000 can take less time to update inspection rules.

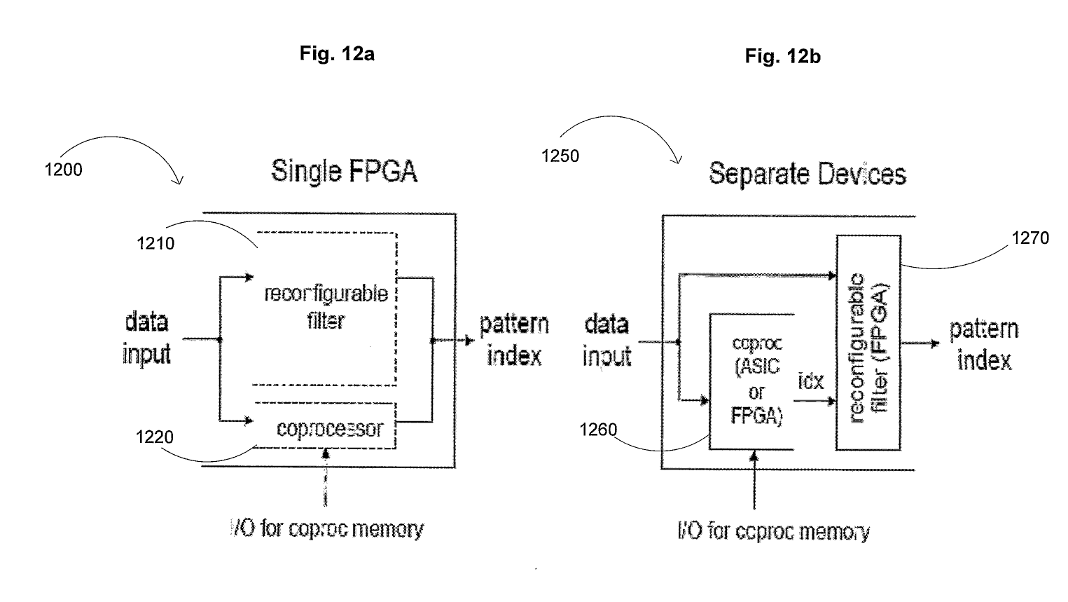

In one aspect of the invention, the reconfigurable deep packet inspection system may be implemented as an integrated circuit and include algorithms optimized for specific patterns, which can reduce the amount of area occupied by the circuit and/or increase the performance of the system. Turning to FIG. 12a, a hybrid deep packet inspection system 1200 is shown, implemented as a single FPGA. The hybrid system 1200 includes a reconfigurable filter 1210, such as those known in the art, and a coprocessor having a dynamic deep packet filter 1220 coupled to the reconfigurable filter 1210 in parallel. Turning to FIG. 12b, another hybrid deep packet inspection system 1250 is shown, implemented as first and second integrated circuits coupled to each other in parallel. The first integrated circuit is a coprocessor, implemented either as an ASIC or an FPGA, having a dynamic deep packet filter 1260, and the second integrated circuit is a reconfigurable filter 1270 implemented as an FPGA. These hybrid configurations 1200/1250 take advantage of the area efficiency and performance of the reconfigurable filter 1210/1270 and the fast rule updates of the dynamic deep packet filters 1220/1260.

The Snort technique used in an NIDS, known in the art, can be implemented in a hybrid system 1200/1250. A current Snort rule set can contain 2,044 unique string patterns consisting of 32,384 bytes. This database of patterns can be implemented using both a reconfigurable filter 1210/1270 known in the art and a dynamic PDM-based filter 1220/1260 implemented in a co-processor. Preferably, the patterns at the time of recompilation are translated and optimized for the reconfigurable filter 1210/1270. For additional patterns to be updated, they can be immediately updated in the dynamic filter 1220/1260.

For the reconfigurable filter, 1210/1270, a primitive block memory unit of a Xilinx Virtex 4 FPGA is used, having the size of 18 kilobits. Any width and depth may be used; however, for a memory unit with 256 entries, each block is preferably configured to have a width of 9 bytes.

For the dynamic filter 1220/1260, there are at least two design considerations, the hardware configuration and the software mapping algorithm. Architectural parameters for the design include dimension of the memories, the number of PDMs, and the hash functions. Depending on the pattern set, the parameters of the architecture may differ to optimize resource utilization. For example, a developer may decide that LPSMs are unnecessary if all the target patterns are short and uniform in length. However, a developer may choose to have a small PDM followed by many parallel LPSMs if the pattern includes a repetitive set of common substrings.

For a Snort NIDS, preferable parameters are herein described. As is known in the art, the length of patterns range from 1 to 122 bytes. Further, the contents of the patterns vary from binary sequences to ASCII string. Thus, the filter preferably accommodates patterns of varying lengths as well as the content. For the pattern set, using different size memories in the PDMs can increase the memory utilization and decrease the logic area. However, it is preferable to set the dimension of all the PDMs to be equal to optimally use the fixed size primitive block memories of a FPGA. Thus, the dimensions of the memory of each PDM are preferably 9 bytes by 256 entries. Since the address pin for each memory is 8 bits, the hash function uses the input byte as its output. Therefore, the minimum length of the pattern detectable with the dynamic filter 1220/1260 having the parameters above is one byte. If the target pattern set does not have uniform distribution of bytes in the pattern, the hash function can generate an index by using more than one byte. Using the hash function may further increase the memory utilization by introducing more diversity in the index. However, the minimum length of the detectable pattern is preferably greater or equal to the hash function input. Nine bytes of each entry are preferably partitioned to hold not only the patterns but their type, length, and hash function input offset. By assigning 2 bits for type information, and 3 bits each for the length and offset, the maximum length of a detectable pattern is 8 bytes.

For applications that do not have any cyclic regular expressions, retrospective LPSMs are preferably used to detect long patterns. A single LPSM with a dimension of 18 bits by 1024 entries can be used. All addresses from four PDMs are mappable with such configuration. Therefore, the indices are not hashed and forwarded as an address to an LPSM entry. 16 of 18 bits of each memory entry are used to store the current segment type, the previous segment index, the delay between the previous and the current segment, and memory entry valid flag.

Once the hardware parameters are determined, the resulting data path can be programmed using several different algorithms. Depending on the complexity of the algorithms and the patterns, there can be a big difference in compilation time as well as the program size. In general, reducing the size of the program takes longer compilation time. However, smaller programs tend to yield cleaner indexing results. The system performance stays constant, regardless the size of the program. For the above hardware, the long patterns are preferably broken into shorter segments of 8 bytes or less. Because of the priorities assigned to the PDM units, the short patterns do not have to be unique. However, eliminating duplicate patterns would save memory space. In order to identify each pattern with a unique index, the last segment of every pattern is preferably different.

In one approach, a heuristic pre-processing method is used to build a keyword tree. There are a number of factors to consider when long patterns are segmented into short patterns. For instance, the last segment of every the long pattern must not overlap any other segment. By processing the patterns such way, the filter will detect a single long pattern. Thus, patterns are preferably segmented having a maximum length. With longer patterns, the PDMs have more choices for hashed index for a given pattern. Further, segments in the middle of one long pattern are preferably not used as a middle segment of another long pattern. Since there is only one entry for one index, such patterns cannot be mapped into the same LPSM unit. With these considerations, an algorithm can divide the long patterns in to several short patterns that fit in the PDMs.

The last segment of maximum length is scanned to build the list of keywords. By iteratively comparing the list with the segment, a list of unique keywords can be checked and built in a single pass of the patterns. When there are overlapping segments, the segments can be modified by shortening the segment by one byte until the minimum length is reached. Once all the last segments are defined, the rest of the segments can be added to the list. The patterns are segmented so that all but the first segment are not allowed to overlap any of the other previously defined segments. When an overlap occurs, segmentation is changed by moving the segment alignment forward or by reducing the segment size from the start or the end of the segment. As the list of pattern segments are generated, index sequences along with all the necessary information for retrospective LPSM are recorded for every long pattern. To store the pattern segments and index sequences to the memory, a mapping algorithm is preferably used to fit the segments into the available PDM entries.

In an alternative preprocessing approach, the following algorithm is used, where:
P=set of all patterns,
S=set of all pattern segments,
L=maximum length of patterns for a PDM,
M=minimum length of patterns for a PDM,
1. Sort the order of patterns in P from the shortest to the longest length;
2. For each pattern in P with length less than or equal to L:
   a. combine all the duplicate patterns,
   b. insert all the unique patterns into a new set S;
3. For each pattern in P with length greater than L:
   a. divide the pattern into segments of length L,
   b. if the length of the last segment of the pattern is less than M, then add (L−the segment length) bytes of the previous segment at the front of the last segment,
   c. compare with S to combine duplicate patterns,
   d. insert all the new segments into the set S,
4. Compare the last segments with the other elements in the set S:
   a. avoid assigning overlapping patterns as the last segment by adding or subtracting bytes of the second to last segment to the front, and
   b. if not possible, make sure the last segment is the longest of all the overlapping segments.

This algorithm executes small string comparisons. However, the algorithm can produce a list of segments containing overlapping patterns, which can yield more complex results. Such overlapping patterns can assert detections in more than one PDM. By assigning a higher priority to the longer of any two overlapping patterns, the detection of the longer index can also indicate the detection of the shorter patterns (as explained above).

In one embodiment, all the PDMs and the LPSMs are memory mapped; however, to a developer, the filter can appear as a large single memory. The parameters of the hash functions can be also treated as a memory mapped location. Before the filter is programmed, the data for the pattern matching modules are preferably mapped on to a virtual filter with a similar configuration. The mapping procedure is necessary to determine the exact address locations for all data. Once the data is correctly mapped in to the virtual memory space, programming the filter is equivalent to writing into a memory. The list of pattern segments, their length, and the control information from the preprocessing step are mapped on to the PDMs. The PDM memory is incrementally filled according to the pattern segment priority and hashed index.

If more than one segment is assigned to an index, the following algorithm may be used to determine a proper index distribution:
1. Produce a histogram vector (A) of all the bytes in the entire pattern set,
2. For each pattern, produce a histogram vector (B) of all the bytes in the pattern,
3. Multiply each index of vector (A) with (B) to produce vector (C),
4. Assign the index with the smallest non-zero value in (C) as the hashed index for the segment,
5. Produce a vector (D) indicating the number of segments hashed to each index,
6. Find all the indices that have more segments than the maximum number of PDMs, and
7. For the indices in 6, attempt to rehash any of the segments into indices with less segments until the number of segments equal the maximum allowed.

For a Snort NIDS, the following algorithm may be used to map preprocessed segments into PDMs:
Let S=set of all preprocessed pattern segments,
1. Sort the order of patterns in S,
   a. sort according to the priority, from the highest to the lowest,
   b. for the patterns with the same priority, sort according to length, from longest to shortest,
   c. for the patterns without any priority, sort according to length, from the longest to the shortest,
2. Set hashing functions parameters for each PDM,
3. For each pattern in S with priority, starting with the first of the set:
   a. generate indices using hash function for the PDM, taking two consecutive bytes at a time,
   b. map all the patterns in to the PDMs:
      i. the overlapping patterns must be mapped into correct PDMs according to their priority,
      ii. if the entries for all the indices are not free, change the target PDM and go to step 3a,
   c. if all the PDMs are attempted, change the PDM hash parameters, reset memory, and go to step 3,
4. For each patter in S without priority, starting with the longest pattern:
   a. generate indices using hash function for the PDM, taking two consecutive bytes at a time,
   b. map all the patterns into the PDMs: if the entries for all the indices are not free, change the target PDM and go to step 4a,
   c. if all the PDMs are attempted, change the PDM hash parameters, reset memory, and go to step 3.

In an alternative approach, the distribution of patterns in the memory considers the frequency of possible indices for each pattern to efficiently map the pattern. The sequences of indices and other control fields are mapped onto the LPSMs. Each index is mapped on to one LPSM pointing to one or more LPSMs that match the corresponding next index. If there are patterns with the same beginning indices, the programmer can choose to use only one LPSM to keep track of all the patterns until it branches off to different patterns. This optimization will allow the unused entries of the LPSMs to be used for other sequences of patterns.

In one embodiment, the hardware design is automatically produced in structural very high speed integrated circuit hardware description language (“VHDL”). The pattern mapping is written in C++ although other software languages may be used. The hardware includes 4 parallel units of PDMs connected to a single unit of retrospective LPSM, however, additional or fewer PDMs may be employed.

Other aspects of the invention are described in the following documents, which are hereby incorporated by reference in their entirety: Young Cho and William H. Mangione-Smith, “High-performance String Search for Network Security using Random-Access-Memories.” Submitted to IEEE Transactions on VLSI Systems (IEEE TVLSI). (http://www.ee.ucla.edu/˜young/pub/tvlsi05.pdf); Young H. Cho and William H. Mangione-Smith, “A Pattern Matching Co-processor for Network Security,” 42nd Design Automation Conference, Anaheim, Calif., Jun. 13-17, 2005, (http://www.ee.ucla.edu/˜young/pub/dac05.pdf); and Young H. Cho and William H. Mangione-Smith, “Fast reconfiguring Deep Packet Filter for 1+ Gigabit Network,” IEEE Symposium on Field-Programmable Custom Computing Machines (FCCM), Napa Valley, Calif., April 2005, (http://www.ee.ucla.edu/˜young/pub/fccm05.pdf).

While embodiments of the present invention have been shown and described, various modifications may be made without departing from the scope of the present invention. The invention, therefore, should not be limited, except to the following claims, and their equivalents.

What is claimed is:

1. A method for detecting one or more malicious programs contained in a data packet received from a network, wherein each malicious program has a unique pattern comprising a plurality of segments, said method comprising the steps of:
storing the pattern of each malicious program in a memory module, wherein each pattern is addressed within the memory module by an index generated by hashing one or more of the segments within the pattern, further wherein the one or more segments to be hashed are hashed at any position within the pattern;
receiving a data packet having a plurality of segments from the network;
generating an index for the received data packet by hashing one or more segments within the received data packet;
searching the memory module for an index matching the index of the received data packet;
retrieving the pattern within the memory corresponding to the index matching the index of the received data packet;
comparing the retrieved pattern with the received data packet; and
outputting the index of the received data packet if the retrieved pattern matches data within the received packet.

2. The method of claim 1, wherein the memory module further stores an offset for each pattern representing the position of the one or more segments hashed within the pattern, the method further comprising the step of delaying the outputting step by the value of the offset.

3. The method of claim 1, further comprising dividing each pattern into a plurality of segments.

4. The method of claim 1, further comprising dividing each pattern into a plurality of segments in accordance with a keyword tree.

5. A deep packet inspection system for detecting one or more malicious programs in a data packet received from a network, wherein each malicious program has a unique pattern comprising a plurality of segments, said system comprising:
a plurality of pattern detection modules configured to receive one or more data packets in parallel, wherein each of the plurality of pattern detection modules has an output and an input; and
one or more multiplexers coupled to the outputs of the plurality of pattern detection modules, wherein each of the one or more multiplexers has an output.

6. The deep packet inspection system of claim 5, further comprising one or more long pattern state machines coupled to the outputs of the one or more multiplexers, wherein the one or more pattern detection modules each include a memory having an entry length and wherein the long pattern state machine is configured to detect patterns that are longer than the width of the memory of a pattern detection module.

7. The deep packet inspection system of claim 6, wherein the one or more long pattern state machines comprise parallel predictive long pattern state machines.

8. The deep packet inspection system of claim 6, wherein the one or more long pattern state machines comprise retrospective long pattern state machines.

9. The deep packet inspection system of claim 5, further comprising a switched pipeline coupled to the output of at least one of the plurality of pattern detection modules.

10. The deep packet inspection system of claim 5, wherein a pattern detection module comprises:
a means for storing the pattern of each malicious program in a memory module, wherein each pattern is addressed within the memory module by an index generated by hashing one or more of the segments within the pattern, further wherein the one or more segments to be hashed are hashed at any position within the pattern;
a means for receiving a data packet having a plurality of segments from the network;
a means for generating an index for the received data packet by hashing one or more segments within the received data packet;
a means for searching the memory module for an index matching the index of the received data packet;
a means for retrieving the pattern within the memory corresponding to the index matching the index of the received data packet;
a means for comparing the retrieved pattern with the received data packet; and
a means for outputting the index of the received data packet if the retrieved pattern matches data within the received packet.

11. The deep packet inspection system of claim 5, wherein a pattern detection module comprises:
a circuit for storing the pattern of each malicious program in a memory module, wherein each pattern is addressed within the memory module by an index generated by hashing one or more of the segments within the pattern, further wherein the one or more segments to be hashed are hashed at any position within the pattern;
a circuit for receiving a data packet having a plurality of segments from the network;
a circuit for generating an index for the received data packet by hashing one or more segments within the received data packet;
a circuit for searching the memory module for an index matching the index of the received data packet;
a circuit for retrieving the pattern within the memory corresponding to the index matching the index of the received data packet;
a circuit for comparing the retrieved pattern with the received data packet; and
a circuit for outputting the index of the received data packet if the retrieved pattern matches data within the received packet.

12. The deep packet inspection system of claim 5, wherein the system is configured to divide each pattern into a plurality of segments in accordance with a keyword tree.

13. The deep packet inspection system of claim 5, further comprising a pattern divider coupled to the inputs of the plurality of pattern detection modules.

14. A deep packet inspection system for detecting one or more malicious programs in a data packet received from a network, wherein each malicious program has a unique pattern comprising a plurality of segments, said system comprising:
a reconfigurable deep packet filter; and
a dynamic deep packet filter coupled to the reconfigurable deep packet filter in parallel.

15. The deep packet inspection system of claim 14, wherein the dynamic deep packet filter is implemented in a coprocessor.

16. The deep packet inspection system of claim 14, wherein the system is implemented as a single field programmable gate array device.

17. The deep packet inspection system of claim 14, wherein the dynamic deep packet filter comprises a plurality of pattern detection modules.

18. The deep packet inspection system of claim 17, wherein the plurality of pattern detection modules each comprises:
a means for storing the pattern of each malicious program in a memory module, wherein each pattern is addressed within the memory module by an index;
a means for receiving a data packet having a plurality of segments from the network;
a means for generating an index for the received data packet;
a means for searching the memory module for an index matching the index of the received data packet;
a means for retrieving the pattern within the memory corresponding to the index matching the index of the received data packet;
a means for comparing the retrieved pattern with the received data packet; and
a means for outputting the index of the received data packet if the retrieved pattern matches data within the received packet.

19. The deep packet inspection system of claim 18, wherein the index is generated by hashing one or more of the segments within the pattern.

20. The deep packet inspection system of claim 19, wherein the one or more segments to be hashed are hashed at any position within the pattern.

21. The deep packet inspection system of claim 18, wherein the index for the received data packet is generated by hashing one or more segments within the received data packet.

22. The deep packet inspection system of claim 17, wherein a pattern detection module comprises:
a circuit for storing the pattern of each malicious program in a memory module, wherein each pattern is addressed within the memory module by an index generated by hashing one or more of the segments within the pattern, further wherein the one or more segments to be hashed are hashed at any position within the pattern;
a circuit for receiving a data packet having a plurality of segments from the network;
a circuit for generating an index for the received data packet by hashing one or more segments within the received data packet;
a circuit for searching the memory module for an index matching the index of the received data packet;
a circuit for retrieving the pattern within the memory corresponding to the index matching the index of the received data packet;
a circuit for comparing the retrieved pattern with the received data packet; and
a circuit for outputting the index of the received data packet if the retrieved pattern matches data within the received packet.

23. The deep packet inspection system of claim 22, wherein the index is generated by hashing one or more of the segments within the pattern.

24. The deep packet inspection system of claim 23, wherein the one or more segments to be hashed are hashed at any position within the pattern.

25. The deep packet inspection system of claim 22, wherein the index for the received data packet is generated by hashing one or more segments within the received data packet.

26. The deep packet inspection system of claim 14, wherein the dynamic deep packet filter comprises:
a plurality of pattern detection modules configured to receive one or more data packets in parallel, wherein each of the plurality of pattern detection modules has an output and an input; and
one or more multiplexers coupled to the outputs of the plurality of pattern detection modules, wherein each of the one or more multiplexers has an output.

27. The deep packet inspection system of claim 26, wherein the dynamic deep packet filter further comprises one or more long pattern state machines coupled to the outputs of the one or more multiplexers, wherein the one or more pattern detection modules each include a memory having an entry length and wherein the long pattern state machine is configured to detect patterns that are longer than the width of the memory of a pattern detection module.

28. The deep packet inspection system of claim 27, wherein the one or more long pattern state machines are parallel predictive long pattern state machines.

29. The deep packet inspection system of claim 27, wherein the one or more long pattern state machines are retrospective long pattern state machines.

30. The deep packet inspection system of claim 14, wherein the dynamic deep packet filter further comprises a switched pipeline coupled to the output of at least one of the plurality of pattern detection modules.

31. The deep packet inspection system of claim 26, further comprising a pattern divider coupled to the inputs of the plurality of pattern detection modules.

32. The deep packet inspection system of claim 14, wherein the system supports a Snort network intrusion detection system.

33. The deep packet inspection system of claim 26, further comprising a priority multiplexer coupled to the outputs of the plurality of pattern detection modules.

34. The deep packet inspection system of claim 14, wherein the dynamic deep packet filter comprises:
a plurality of pattern detection modules operating in parallel, each having an input and an output;
a switched pipeline coupled to the outputs of the plurality of pattern detection modules; and
a long pattern state machine coupled to the outputs of the plurality of pattern detection modules in parallel with the switched pipeline.

35. The deep packet inspection system of claim 34, wherein the one or more long pattern state machines are parallel predictive long pattern state machines.

36. The deep packet inspection system of claim 34, wherein the one or more long pattern state machines are retrospective long pattern state machines.

37. The deep packet inspection system of claim 34, further comprising a pattern divider coupled to the inputs of the plurality of pattern detection modules.

38. The deep packet inspection system of claim 37, wherein the pattern divider operates in accordance with a keyword tree.
